(19) United States
(12) Patent Application Publication
(10) Pub. No.: US 2018/0232643 A1
(43) Pub. Date: Aug. 16, 2018

(54) IDENTIFYING USER ENGAGEMENT BASED UPON EMOTIONAL STATE

(71) Applicant: International Business Machines Corporation, Armonk, NY (US)

(72) Inventors: Vijay Ekambaram, Chennai (IN); Pratyush Kumar, Chennai (IN); Ashok Pon Kumar Sree Prakash, Bangalore (IN)

(21) Appl. No.: 15/429,820

(22) Filed: Feb. 10, 2017

(51) Int. Cl. G06N 5/04; G06F 1/16

(52) U.S. Cl. CPC G06N 5/04; G06F 1/163

(57) ABSTRACT

One embodiment provides a method, including: an application receiving, from a requesting application, a request for identifying an attribute of user behavior regarding his or her use of the requesting application, wherein the attribute corresponds to an emotional state of the user; identifying, from at least one wearable device operatively coupled to the receiving application, a plurality of sensors accessible to the receiving application; identifying, from the plurality of accessible sensors, at least one sensor that monitors information corresponding to the attribute; determining the value of the attribute by analyzing the information of the at least one sensor, wherein the analyzing comprises comparing the obtained information to information stored in at least one user behavior model directed to the attribute; and providing the determined value of the attribute to the requesting application, whereupon the requesting application modifies a parameter of the requesting application based upon the provided determined value.

### BACKGROUND

The technology of information handling devices (e.g., laptop computers, smart watches, smart phones, tablets, smart televisions, etc.) has increased so that many people have at least one information handling device. Additionally, the advances in technology have resulted in portable or wearable information handling devices (e.g., laptops, tablets, smart watches, smart glasses, smart footwear, etc.). Accordingly, most users have at least one information handling device that they carry with them.

Information handling devices allow a user to interact with the device to perform different functions. Many of these devices provide applications (e.g., gaming applications, word processing applications, database applications, personal development applications, note-taking applications, etc.) that allow a user to perform a function or complete a task. For example, a user may interface with an application to play games, record notes, meditate, and the like. The developer of an application attempts to develop an application which a user can easily interact with and provides engagement with the user. For example, in the context of a gaming application, the developer may create a game in which the difficulty of the game increases as the user progresses through or continues to play the game.

### BRIEF SUMMARY

In summary, one aspect of the invention provides a method, comprising: utilizing at least one processor to execute computer code that performs the steps of: an application receiving, from a requesting application, a request for identifying an attribute of user behavior regarding his or her use of the requesting application, wherein the attribute corresponds to an emotional state of the user; identifying, from at least one wearable device operatively coupled to the receiving application, a plurality of sensors accessible to the receiving application; identifying, from the plurality of accessible sensors, at least one sensor that monitors information corresponding to the attribute; determining the value of the attribute by analyzing the information of the at least one sensor, wherein the analyzing comprises comparing the obtained information to information stored in at least one user behavior model directed to the attribute; and providing the determined value of the attribute to the requesting application, whereupon the requesting application modifies a parameter of the requesting application based upon the provided determined value.

Another aspect of the invention provides an apparatus, comprising: at least one processor; and a computer readable storage medium having computer readable program code embodied therewith and executable by the at least one processor, the computer readable program code comprising: computer readable program code that receives at an application, from a requesting application, a request for identifying an attribute of user behavior regarding his or her use of the requesting application, wherein the attribute corresponds to an emotional state of the user; computer readable program code that identifies, from at least one wearable device operatively coupled to the receiving application, a plurality of sensors accessible to the receiving application; computer readable program code that identifies, from the plurality of accessible sensors, at least one sensor that monitors information corresponding to the attribute; computer readable program code that determines the value of the attribute by analyzing the information of the at least one sensor, wherein the analyzing comprises comparing the obtained information to information stored in at least one user behavior model directed to the attribute; and computer readable program code that provides the determined value of the attribute to the requesting application, whereupon the requesting application modifies a parameter of the requesting application based upon the provided determined value.

An additional aspect of the invention provides a computer program product, comprising: a computer readable storage medium having computer readable program code embodied therewith, the computer readable program code executable by a processor and comprising: computer readable program code that receives at an application, from a requesting application, a request for identifying an attribute of user behavior regarding his or her use of the requesting application, wherein the attribute corresponds to an emotional state of the user; computer readable program code that identifies, from at least one wearable device operatively coupled to the receiving application, a plurality of sensors accessible to the receiving application; computer readable program code that identifies, from the plurality of accessible sensors, at least one sensor that monitors information corresponding to the attribute; computer readable program code that determines the value of the attribute by analyzing the information of the at least one sensor, wherein the analyzing comprises comparing the obtained information to information stored in at least one user behavior model directed to the attribute; and computer readable program code that provides the determined value of the attribute to the requesting application, whereupon the requesting application modifies a parameter of the requesting application based upon the provided determined value.

A further aspect of the invention provides a method, comprising: utilizing at least one processor to execute computer code that performs the steps of: an application receiving, from a requesting application, at least one user behavior hook, wherein the at least one user behavior hook provides an indication of an attribute of behavior by a user using the requesting application, wherein the attribute of behavior corresponds to an emotional state of the user; accessing, from at least one wearable device operatively coupled to the receiving application, a plurality of sensors that provide information corresponding to attributes of the user; identifying, from the plurality of sensors, at least one sensor relevant to information corresponding to the requested user behavior hook; determining a value of the attribute of behavior by analyzing information provided by the identified at least one relevant sensor, wherein the analyzing comprises comparing the information provided by the at least one relevant sensor to a catalog comprising models of attributes of behavior; and providing, to the requesting application, the determined value of the attribute of behavior.

For a better understanding of exemplary embodiments of the invention, together with other and further features and advantages thereof, reference is made to the following description, taken in conjunction with the accompanying drawings, and the scope of the claimed embodiments of the invention will be pointed out in the appended claims.

### BRIEF DESCRIPTION OF THE SEVERAL VIEWS OF THE DRAWINGS

FIG. 1 illustrates a method of identifying user behavior based upon a user's emotional state.

FIG. 2 illustrates example wearable devices and sensors accessible by the wearable devices.

FIG. 3 illustrates an example flow for identifying user behavior from a request.

FIG. 4 illustrates a computer system.

### DETAILED DESCRIPTION

It will be readily understood that the components of the embodiments of the invention, as generally described and illustrated in the figures herein, may be arranged and designed in a wide variety of different configurations in addition to the described exemplary embodiments. Thus, the following more detailed description of the embodiments of the invention, as represented in the figures, is not intended to limit the scope of the embodiments of the invention, as claimed, but is merely representative of exemplary embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in at least one embodiment. In the following description, numerous specific details are provided to give a thorough understanding of embodiments of the invention. One skilled in the relevant art may well recognize, however, that embodiments of the invention can be practiced without at least one of the specific details thereof, or can be practiced with other methods, components, materials, et cetera. In other instances, well-known structures, materials, or operations are not shown or described in detail to avoid obscuring aspects of the invention.

The illustrated embodiments of the invention will be best understood by reference to the figures. The following description is intended only by way of example and simply illustrates certain selected exemplary embodiments of the invention as claimed herein. It should be noted that the flowchart and block diagrams in the figures illustrate the architecture, functionality, and operation of possible implementations of systems, apparatuses, methods and computer program products according to various embodiments of the invention. In this regard, each block in the flowchart or block diagrams may represent a module, segment, or portion of code, which comprises at least one executable instruction for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

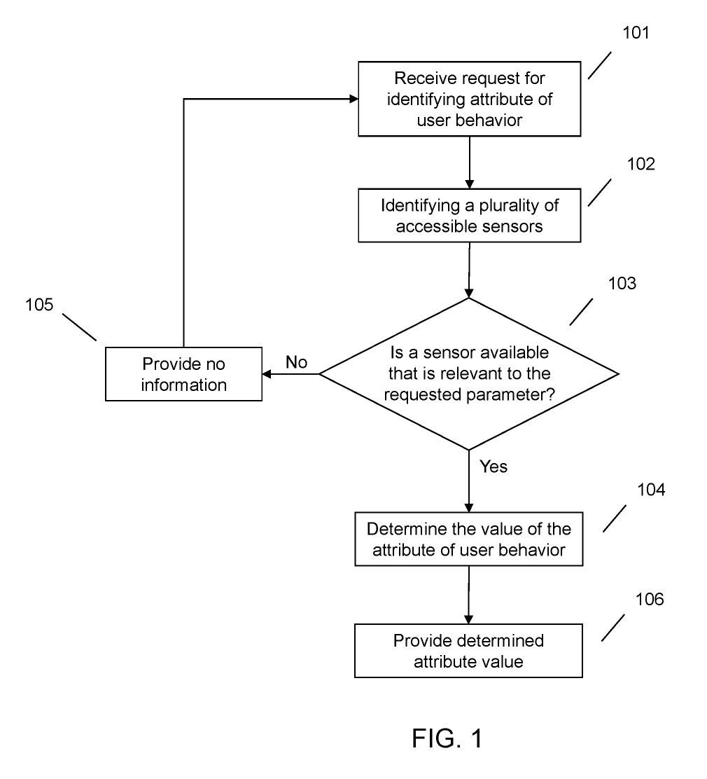

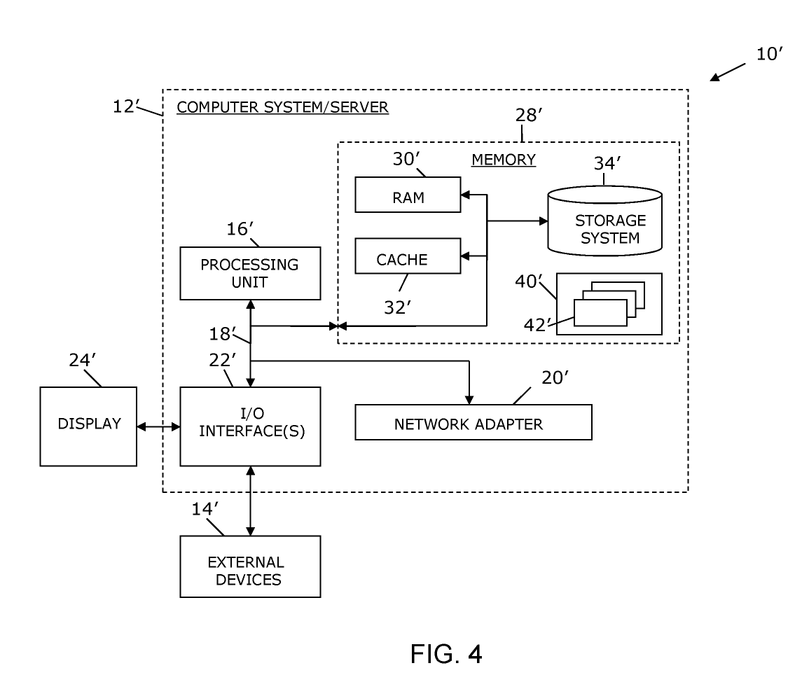

Specific reference will be made here below to FIG. 1-4. It should be appreciated that the processes, arrangements and products broadly illustrated therein can be carried out on, or in accordance with, essentially any suitable computer system or set of computer systems, which may, by way of an illustrative and non-restrictive example, include a system or server such as that indicated at 12′ in FIG. 4. In accordance with an example embodiment, most if not all of the process steps, components and outputs discussed with respect to FIG. 1-3 can be performed or utilized by way of a processing unit or units and system memory such as those indicated, respectively, at 16′ and 28′ in FIG. 4, whether on a server computer, a client computer, a node computer in a distributed network, or any combination thereof.

Application developers want users to use the applications that they develop. Accordingly, a developer wants to estimate the user experience while a user is interacting with the application. Identification of the user experience can assist a developer in enhancing the application so that the user continues to engage in the application. Additionally, if the user experience can be identified in or near real-time the developer may be able to modify the model of the application in response to the identified user experience in or near real-time. For example, in the context of a game, the developer may program the application to respond to the user experience to result in a game that is less frustrating or more challenging to the user, depending on the user's experience with the application.

However, conventional methods for estimating the user experience are often misleading or inefficient. One conventional method of estimating a user's experience is by requesting user feedback. For example, after interacting with an application, the user may be requested to fill out a survey related to his/her experience interacting with the application. One problem with such an approach is that these surveys are typically provided after the user has finished interacting with the application. Thus, the feedback is not provided in real-time. Additionally, many users may refuse to take the survey, thereby giving only a small sample size regarding user experiences. In addition, users may only take surveys if they are very unsatisfied with the application. Therefore, the user feedback may be skewed towards users not liking the user experience. This could result in an application developer incorrectly adjusting the application to compensate for these users, even though many users may be satisfied with the previous version of the application.

Another conventional method for estimating a user's experience is to capture a user's engagement or behavior with the application while the user is using the application. These methods are typically based on the user's interactions with the application. For example, a system may identify if a user is providing user input (e.g., via a keyboard, mouse, touch screen, etc.), looking at the device (e.g., using a camera, etc.), or based on voice signals (e.g., the user is providing audio relevant to the application, etc.). However, these approaches may be very misleading. For example, a user may be involved with the application even though he/she is no longer interacting with the application. As an example, a user may be playing a game which requires the user to provide an instruction and then wait for the application to carry out the instruction. While the application is carrying out the instruction, the user may look away from the device and start talking to someone else in the room. Using the conventional methods, the system would determine that the user's engagement with the application is low, even though the user is still engaged with the application.

Additionally, to capture the user interaction with the application, the application developer has to program the application to capture these interactions. While most devices have cameras, microphones, and speakers, not all devices have other sensors, for example, accelerometers, gyroscopes, pressure sensors, and the like. Accordingly, the developer has to program the application for each type of device that the application may be installed on. Additionally, since some devices may have certain sensors and others do not, the developer may have to program the application to not capture some sensor information that may be relevant. In addition, the application also has to be programmed to analyze the information received from the sensors. Therefore, the application developer has to continually reprogram the application to account for the changing devices and sensors and also spend a large amount of time programing the application to analyze the large amounts of information it may receive from the sensor. Thus, the application developer spends less time programming the application for the actual intended function, and more time programing the application to capture and analyze information related to user interactions.

Accordingly, an embodiment provides a system and method of evaluating a user behavior or engagement with an application as the user is engaging with or using the application. The terms behavior and engagement will be used interchangeably herein. The system may receive, from a requesting application, a request for identifying an attribute of user behavior or engagement with respect to the requesting application. The attribute of user engagement may include a specific request related to an emotional state of the user. For example, the request may be a request to identify a stress level of the user while interacting with the requesting application. As another example, the request may be a request to identify a frustration level of the user while interacting with the requesting application.

The system may then identify accessible sensors. These sensors may be included in devices that are either attached to or connected to a user's body (collectively referred to herein as “wearable devices”). For example, the system may identify that a user has a smart watch, laptop computer, and fitness tracker. Each of these devices may include sensors accessible by the respective device. For example, the fitness tracker may include a heart rate monitor and accelerometer, the laptop computer may include a camera and microphone, and the smart watch may include pressure and electromyography sensors. From these sensors the system may identify which sensors may provide information relevant to the requested attribute of user engagement. For example, if the attribute is a request for stress level, the system may identify the heart rate monitor and camera as sensors which could provide information relevant to the stress level of the user.

Once the information is obtained from the relevant sensors, the system may determine a value of the attribute of user engagement by analyzing the information. In one embodiment, the system may make this determination by comparing the obtained information to information stored in one or more user engagement models. The user engagement models may correspond to the requested attribute. For example, each user engagement model may correspond to a particular user attribute. Therefore, using this example, the system may have one or more user engagement models specific to user stress level. The system may then feed or compare the information to the corresponding model and then identify a value for the attribute. Using the previous example, the system may feed the heart rate monitor information and camera information to a stress model and determine the stress level of the user. The attribute can then be provided to the requesting application.

Such a system provides a technical improvement over current systems for assessing user engagement with an application. The system and method as described herein may be integrated into an application or act as a standalone application that an application developer can interface with. As a standalone application, the application developer of the desired application only has to write a very short program to interface with the application. The disclosed system and application can then capture the user interaction information in or close to real-time and then provide this information to the developer of the target application. A developer can then correct or change the model of the application as the user is engaging with the application, in order to keep the user engaged with the application for longer periods of time, without having to program his/her application to capture such information. Therefore, the application developer can spend more time developing the application and less time programming the application to capture such information.

FIG. 1 illustrates an example method for identifying user engagement based upon an emotional state of the user. At 101, an embodiment may receive, from a requesting application, a request for identifying an attribute of user behavior with respect to the requesting application. The attribute of user engagement may be related to an emotional state of the user. For ease of understanding, the stress level example as previously used will continue to be used throughout. However, it should be understood by one skilled in the art that other attributes may be requested and identified, for example, user frustration level, user happiness, user calmness, and the like. In one embodiment the attribute of user engagement may also be related to a user activity level with respect to the application. For example, in addition to requesting an emotional state of the user, the requesting application may also request an activity level of the user.

Rather than receiving a request for a specific attribute (e.g., heart rate, pressure input, etc.), the system may instead receive an engagement hook or context information which can be analyzed to determine the specific attribute. The context information that is received from the requesting application may be analyzed to determine the relevant engagement hook. An engagement hook is an identification of a pattern of a human attribute. For example, an engagement hook may include a pattern in heart rate, pattern in pupil enlargement, pattern in pressure of touch input, and the like. Thus, the requesting application may provide context which identifies the engagement hook. For example, the system may identify that the requesting application is a gaming application where the difficulty increases as the user increases levels or continues to play. The system may also identify that the difficulty level is at least partially dependent on the ability of the user. For example, one user who may only play the game once a week may have a lower ability level than a user who plays the game daily. Thus, the system may determine that a user with a lower ability will likely get frustrated if the difficulty increases too much. Accordingly, the context received by the system may include frustration level and one of the corresponding engagement hooks may be a pattern of heart rate.

In one embodiment the request may be a direct request from the requesting application. For example, the requesting application may send an instruction to the system which provides an indication of the desired attribute or engagement hook. In one embodiment, the request may not be a direct request; rather, the system may receive contextual data from the requesting application. The system may then identify the attribute which may be relevant to the requesting application based upon the contextual data.

At 102, the system may identify a plurality of sensors accessible to the system. These sensors may be included on the device that the user is using to interact with the application. Additionally, the sensors may be included on devices accessible or operatively coupled to the device. For example, multiple devices of a user may be known to a cloud account or Internet account of a user. As an example, the user may have multiple ANDROID® devices which are all linked to the user's GOOGLE® account. Thus, one of the devices is operatively coupled to and may access information from each of the other connected devices. As another example, a user's devices may all be connected to a home network. The devices may then access information from the other devices through the home network. As a further example, the user may connect the devices together using near field communication methods, wireless communication methods, wired communication methods, and the like. Additionally, the devices may be operatively coupled using a combination of any of these methods.

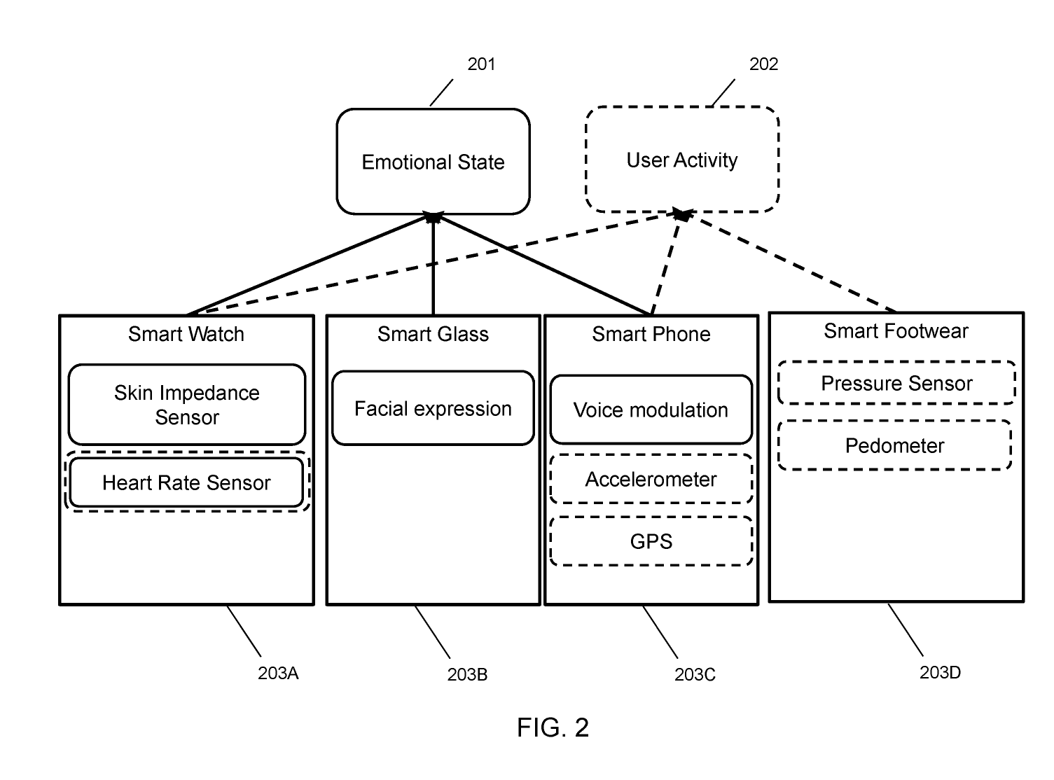

FIG. 2 shows an example of devices and possible sensors which may be included or accessible by the device. Example devices may include a smart watch 203A, smart glass 203B, smart phone 203C, and smart footwear 203D. Smart watch 203A may include skin impedance and heart rate sensors. Smart glass 203B may include sensors for capturing facial expression. Smart phone 203C may include sensors for capturing voice modulation, an accelerometer, and global positioning (GPS) sensor. Smart footwear 203D may include a pressure sensor and pedometers. As should be understood, the devices and sensors are merely examples and other devices and sensors are contemplated. Each of the sensors may capture information relevant to a user's emotional state 201 (the sensors corresponding to emotional state are shown in solid lines) and/or a user's activity (the sensors corresponding to activity are shown in dashed lines). Also, as should be understood, these are merely examples and the sensors may be used for something other than what is depicted. For example, a skin impedance sensor may be used to determine a user activity rather than emotional state.

At 103, the system may identify which, if any, of the accessible sensors are relevant to the requested attribute. For example, if the requested attribute is related to a stress level, the system may identify any sensors which may provide an indication of stress level as relevant sensors. After identifying the relevant sensors, the system may request information from the identified sensor, for example, by querying the sensor, querying the device, and the like. Alternatively, the sensors may continually provide information to the system and, after identifying the relevant sensor, the system may process the information received from those sensors. As should be understood, more than one sensor may provide information relevant to the requested attribute.

In one embodiment, the system may query a user behavior database to identify the sensor data which would be relevant to the attribute. The user behavior database may include models which correspond to attributes of user engagement. For example, the database may include one or more models which correspond to stress level, one or more different models corresponding to user happiness, and the like. Each of the models may include information related to sensor information for identifying the status of the attribute. For example, the model may include a decision tree which guides the system to a conclusion based upon particular sensor information. Each of the models may also include an identification of what type of sensor information is required to use or traverse the model. For example, a user stress model may indicate that the model requires at least two sets of sensor information selected from heart rate, pressure input, body temperature, voice volume, and the like. Thus, based upon the requested attribute, the system may access the corresponding model to identify what sensor information could be used to determine the attribute. The user behavior database may be updated periodically based upon feedback or new information.

In the case of multiple sensors providing information relevant to the requested attribute, sometimes the sensor information may provide conflicting results, for example, sensor information from one sensor may indicate a high level of stress whereas information from another sensor indicates a low level of stress. Accordingly, the system may need to filter or choose the information to be used in determining the requested attribute.

In one embodiment, the system may use a voting or consensus function. For example, if two sensors indicate one attribute value and a third sensor indicates a different attribute value, the third sensor information may not be used. Another method for selecting sensor information is to weight the sensor information. For example, the system may weight the sensor information based upon a determined reliability of the information. The reliability may be determined based upon past indications and the correctness of those indications. The system may weight the sensor information based upon the location of the device to the user. For example, a device located three feet from a user and providing facial information may be weighted lower than a device located a foot from the user providing facial information. Other methods for selecting sensor information are possible and contemplated, for example, ranking or prioritizing the sensor information or device, weighting the sensor information based on feedback from the requesting application, and the like.

If no sensors are relevant to the requested attribute at 103 the system may provide no information to the requesting application at 105 and wait for a new request at 101. If, however, at least one sensor is relevant to the requested attribute, the system may determine a value of the attribute of user engagement at 104. To make the determination of the value of the attribute, the system may analyze the information received from the relevant sensors. In analyzing information received from multiple sources, the system may use intelligent collating algorithms to integrate the information from the multiple sources.

The value of the attribute of user engagement may also be based upon the activity level of the user. For example, the sensor data may indicate a particular emotional state of the user. However, the system may identify that the user is currently not interacting with the application and may additionally identify that the user is talking to another person. Accordingly, the system may attribute the emotional state of the user to the conversation with the other person rather than with the application. In other words, the system may apply some filtering in order to not incorrectly attribute emotional states to the requesting application.

The analyzing may include comparing the obtained information to information stored in at least one user engagement model related to the attribute of user engagement. The at least one user engagement model may be the same or a similar model to the models described above with respect to the user behavior database. The user engagement model may also be based upon a user profile for a user. For example, the system may generate a user profile for a user. This profile may provide an indication of baseline values for attributes related to user engagement. Additionally, the profile may include models which are specific to that user. For example, the user profile may include information related to the types of devices and sensors that a particular user uses. Thus, any models that require different devices or sensors may not be included in the user profile. The user profile and models within the profile may be updated based upon predetermined events (e.g., connection of a new device, periodically, based on user requests, etc.).

The system may then traverse, poll, or query the model using the obtained information to determine a value or level for the requested attribute. For example, the result of the model may identify a user's stress level as high. The value or level for the requested attribute may be a number (e.g., 1, 5, 10, etc.), word value (e.g., high, medium-high, low, etc.), range (e.g., 3-5, medium-high to high, etc.), a comparison of the level to a previous level of the user (e.g., the value is higher than five minutes ago, the value is higher than the last time the user accessed the application, etc.), and the like. Accordingly, the attribute may provide an indication of the effect of the application on the user's emotional state. For example, if the stress level is higher than before, the system or requesting application, may surmise that the requesting application is stressing the user.

At 106 the system may provide the determined attribute to the requesting application. The requesting application may then use this information to modify the model or an attribute of the application, for example, changing the difficulty level of a game based upon a stress or frustration level of a user. As another example, the requesting application may be a meditation application, and based upon the determined attribute, the meditation application may increase the duration of the meditation exercise.

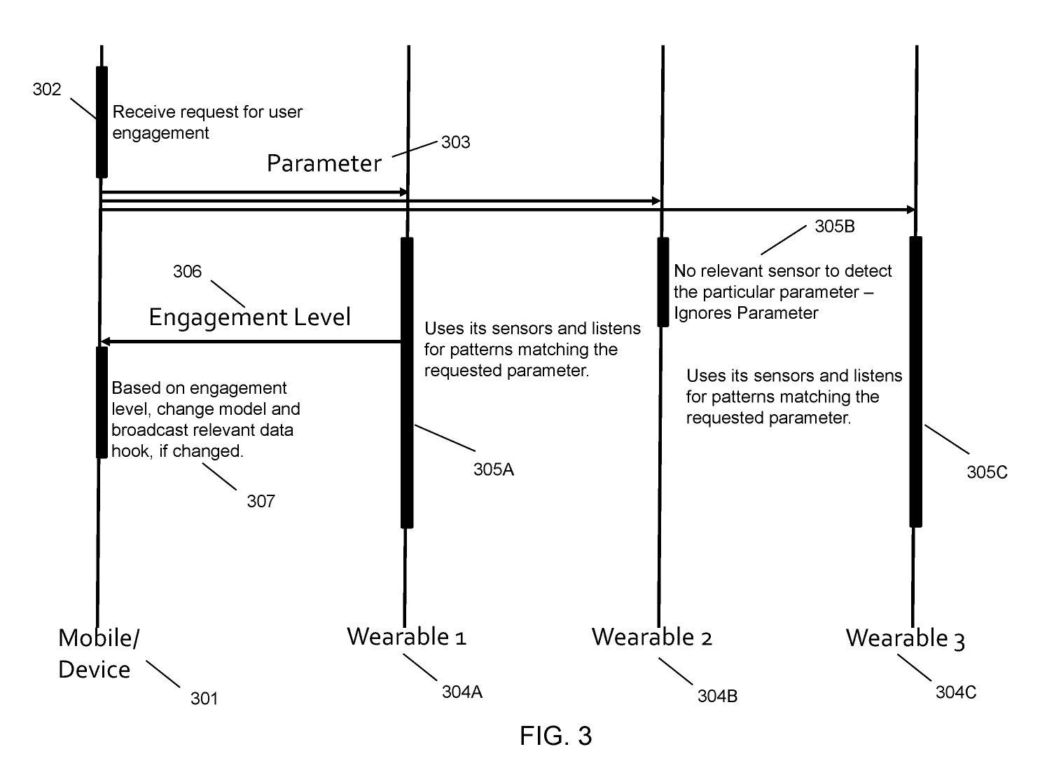

As a brief overall example of the system, FIG. 3 illustrates an example flow of the method and system as described herein. A mobile device or other device 301, which includes or can access the system as described herein, can receive a request for user engagement 302 including an attribute 303. Based upon the attribute 303, the wearable devices 304A, 304B, and 304C are notified of the attribute 303. Based upon the sensors of the device (304A-304C), the device (304A-304C) may provide sensor information relevant to the attribute 303. For example, devices 304A and 304C have sensors that can provide relevant information, so they use sensors and listen for patterns matching the requested attribute 305A and 305C. However, device 304B does not have sensors that can provide relevant information, so it ignores the attribute 305B. The sensor information obtained from devices 304A and 304C is used to determine the engagement level of the user 306. The requesting device may then change the application model and broadcast the relevant data hook if the model was changed 307.

As shown in FIG. 4, computer system/server 12′ in computing node 10′ is shown in the form of a general-purpose computing device. The components of computer system/server 12′ may include, but are not limited to, at least one processor or processing unit 16′, a system memory 28′, and a bus 18′ that couples various system components including system memory 28′ to processor 16′. Bus 18′ represents at least one of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12′ typically includes a variety of computer system readable media. Such media may be any available media that are accessible by computer system/server 12′, and include both volatile and non-volatile media, removable and non-removable media.

System memory 28′ can include computer system readable media in the form of volatile memory, such as random access memory (RAM) 30′ and/or cache memory 32′. Computer system/server 12′ may further include other removable/non-removable, volatile/non-volatile computer system storage media. By way of example only, storage system 34′ can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18′ by at least one data media interface. As will be further depicted and described below, memory 28′ may include at least one program product having a set (e.g., at least one) of program modules that are configured to carry out the functions of embodiments of the invention.

Program/utility 40′, having a set (at least one) of program modules 42′, may be stored in memory 28′(by way of example, and not limitation), as well as an operating system, at least one application program, other program modules, and program data. Each of the operating systems, at least one application program, other program modules, and program data or some combination thereof, may include an implementation of a networking environment. Program modules 42′ generally carry out the functions and/or methodologies of embodiments of the invention as described herein.

Computer system/server 12′ may also communicate with at least one external device 14′ such as a keyboard, a pointing device, a display 24′, etc.; at least one device that enables a user to interact with computer system/server 12′; and/or any devices (e.g., network card, modem, etc.) that enable computer system/server 12′ to communicate with at least one other computing device. Such communication can occur via I/O interfaces 22′. Still yet, computer system/server 12′ can communicate with at least one network such as a local area network (LAN), a general wide area network (WAN), and/or a public network (e.g., the Internet) via network adapter 20′. As depicted, network adapter 20′ communicates with the other components of computer system/server 12′ via bus 18′. It should be understood that although not shown, other hardware and/or software components could be used in conjunction with computer system/server 12′. Examples include, but are not limited to: microcode, device drivers, redundant processing units, external disk drive arrays, RAID systems, tape drives, and data archival storage systems, etc.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method, comprising:
utilizing at least one processor to execute computer code that performs the steps of:
an application receiving, from a requesting application, a request for identifying an attribute of user behavior regarding his or her use of the requesting application, wherein the attribute corresponds to an emotional state of the user;
identifying, from at least one wearable device operatively coupled to the receiving application, a plurality of sensors accessible to the receiving application;
identifying, from the plurality of accessible sensors, at least one sensor that monitors information corresponding to the attribute;
determining the value of the attribute by analyzing the information of the at least one sensor, wherein the analyzing comprises comparing the obtained information to information stored in at least one user behavior model directed to the attribute; and
providing the determined value of the attribute to the requesting application, whereupon the requesting application modifies a parameter of the requesting application based upon the provided determined value.

2. The method of claim 1, wherein the identifying at least one sensor comprises querying a user behavior database to identify sensor data corresponding to the attribute of user behavior.

3. The method of claim 1, wherein the identifying at least one sensor comprises identifying a plurality of sensors.

4. The method of claim 3, wherein information received by one of the plurality of sensors conflicts with information received by another one of the plurality of sensors.

5. The method of claim 4, comprising ranking the plurality of sensors and selecting information from one of the plurality of sensors based upon the ranking.

6. The method of claim 1, wherein the attribute of user behavior is identified based upon contextual data received from the requesting application.

7. The method of claim 1, wherein the value of the attribute is based, at least in part, on a user activity level with respect to the requesting application.

8. The method of claim 1, wherein the identifying a plurality of sensors comprises identifying sensors operatively coupled to the receiving application via a user account.

9. The method of claim 1, comprising generating a user behavior profile for a particular user.

10. The method of claim 9, wherein the at least one user behavior model is based upon the user behavior profile.

11. An apparatus, comprising:
at least one processor; and
a computer readable storage medium having computer readable program code embodied therewith and executable by the at least one processor, the computer readable program code comprising:
computer readable program code that receives at an application, from a requesting application, a request for identifying an attribute of user behavior regarding his or her use of the requesting application, wherein the attribute corresponds to an emotional state of the user;
computer readable program code that identifies, from at least one wearable device operatively coupled to the receiving application, a plurality of sensors accessible to the receiving application;
computer readable program code that identifies, from the plurality of accessible sensors, at least one sensor that monitors information corresponding to the attribute;
computer readable program code that determines the value of the attribute by analyzing the information of the at least one sensor, wherein the analyzing comprises comparing the obtained information to information stored in at least one user behavior model directed to the attribute; and
computer readable program code that provides the determined value of the attribute to the requesting application, whereupon the requesting application modifies a parameter of the requesting application based upon the provided determined value.

12. A computer program product, comprising:
a computer readable storage medium having computer readable program code embodied therewith, the computer readable program code executable by a processor and comprising:
computer readable program code that receives at an application, from a requesting application, a request for identifying an attribute of user behavior regarding his or her use of the requesting application, wherein the attribute corresponds to an emotional state of the user;
computer readable program code that identifies, from at least one wearable device operatively coupled to the receiving application, a plurality of sensors accessible to the receiving application;
computer readable program code that identifies, from the plurality of accessible sensors, at least one sensor that monitors information corresponding to the attribute;
computer readable program code that determines the value of the attribute by analyzing the information of the at least one sensor, wherein the analyzing comprises comparing the obtained information to information stored in at least one user behavior model directed to the attribute; and
computer readable program code that provides the determined value of the attribute to the requesting application, whereupon the requesting application modifies a parameter of the requesting application based upon the provided determined value.

13. The computer program product of claim 12, wherein the identifying at least one sensor comprises querying a user behavior database to identify sensor data corresponding to the attribute of user behavior.

14. The computer program product of claim 12, wherein the identifying at least one sensor comprises identifying a plurality of sensors.

15. The computer program product of claim 14, wherein information received by one of the plurality of sensors conflicts with information received by another one of the plurality of sensors.

16. The computer program product of claim 15, comprising ranking the plurality of sensors and selecting information from one of the plurality of sensors based upon the ranking.

17. The computer program product of claim 12, wherein the attribute of user behavior is identified based upon contextual data received from the requesting application.

18. The computer program product of claim 12, wherein the value of the attribute is based, at least in part, on a user activity level with respect to the requesting application.

19. The computer program product of claim 12, comprising generating a user behavior profile for a particular user and wherein the at least one user behavior model is based upon the user behavior profile.

20. A method, comprising:
utilizing at least one processor to execute computer code that performs the steps of:
an application receiving, from a requesting application, at least one user behavior hook, wherein the at least one user behavior hook provides an indication of an attribute of behavior by a user using the requesting application, wherein the attribute of behavior corresponds to an emotional state of the user;
accessing, from at least one wearable device operatively coupled to the receiving application, a plurality of sensors that provide information corresponding to attributes of the user;
identifying, from the plurality of sensors, at least one sensor relevant to information corresponding to the requested user behavior hook;
determining a value of the attribute of behavior by analyzing information provided by the identified at least one relevant sensor, wherein the analyzing comprises comparing the information provided by the at least one relevant sensor to a catalog comprising models of attributes of behavior; and
providing, to the requesting application, the determined value of the attribute of behavior.
